(19) United States
(12) Patent Application Publication
(10) Pub. No.: US 2009/0245940 A1
(43) Pub. Date: Oct. 1, 2009

(54) ROTATABLE MULTI-JOINT INSTALLATION

(75) Inventor: EUGENE ALEXANDER BAJEMA, Katwijk a/d Rijn (NL)

Correspondence Address: HOFFMANN & BARON, LLP, 6900 JERICHO TURNPIKE, SYOSSET, NY, 11791, US

(73) Assignee: HEEREMA MARINE CONTRACTORS NEDERLAND B.V., Leiden (NL)

(21) Appl. No.: 12/414,800

(22) Filed: Mar. 31, 2009

Related U.S. Application Data
(60) Provisional application No. 61/041,028, filed on Mar. 31, 2008.

(51) Int. Cl. F16L 1/12

(52) U.S. Cl. 405/167

(57) ABSTRACT

The invention relates to a multi-joint installation configured to join two or more pipe sections. The multi-joint installation is rotatable about an axis of rotation between a substantially horizontal and a substantially vertical position. The multi-joint installation includes two or more holding devices for holding two or more pipe sections, and at least one joining device for joining the two or more pipe sections to each other.

### CROSS-REFERENCE TO RELATED APPLICATIONS

This application claims the benefit of U.S. Provisional Application No. 61/041,028, filed Mar. 31, 2008, the contents of which is incorporated by reference herein.

### FIELD OF THE INVENTION

The present invention relates to a system and method for assembling pipe sections.

### BACKGROUND OF THE INVENTION

In the offshore industry there is a need for underwater pipelines. These underwater pipelines may be provided by joining pipe sections together to form a pipeline which is lowered from a vessel to an underwater bottom, for instance the bottom of the sea.

Pipe sections delivered by pipe mills have a length that is generally in the order of no more than 12 meters. One such section is known in the industry as a “single joint”.

During installation of the pipeline, single joints may be welded together on a pipe lay vessel, thereby forming the pipeline. In order to maximize layspeeds, it is in general advantageous to use longer pipe sections on board of the vessel, since this will lead to less welds to be made offshore in critical time.

Longer pipe sections can be made onshore, prior to transportation of the pipe sections to the lay vessel, or offshore, for instance on a pipe-laying vessel. This is done via the process generally known as multi jointing, whereby single joints are welded together to form so called “multi joints”. One multi joint may for instance consist of two, three, four or more single joints.

There are various methods in use to make a pipeline. The process of S-lay consists of horizontal connection of pipe sections on the lay vessel. The production process of preparation, welding, weld testing and coating is divided over multiple stations. After completion of a section, the pipeline is overboarded via a so called stinger, over which the pipeline is bend to change the orientation from the horizontal fabrication position to a downwardly inclined or even near vertical orientation in order to be laid on the sea floor.

Another method of construction is so called J-lay process. For this method, a pipelaying tower is positioned on the pipelay vessel. The pipeline is hung off in a downwardly inclined or even near vertical position in the tower, after which pipe sections are added on top of the already completed pipeline in this orientation. In order to obtain a high layspeed, the number of welds made on the critical path in the tower should be kept as small as possible. Especially when there is only one welding station in the tower, longer pipe sections to be added to the pipeline are beneficial. This can lead to using for instance multi joints consisting of six or more single joints, with a resulting length of over 70 meters. Since it is difficult to handle and transport pipe sections in these lengths to the vessel, on board of the vessel multi jointing may take place. Single, double, triple or quad joints are provided to the vessel, from which on the vessel sections of the appropriate length to be used in the J-lay tower are manufactured.

Known multi jointing processes, both onshore and offshore, generally weld pipe sections in a horizontal orientation. This method has some disadvantages.

First of all, different welding procedures are required for welding pipe sections in a horizontal orientation (known as the 5G position where the pipe is stationary and the welding equipment moves around the pipe, or the 1G position, where the pipe is rotated and the welding equipment remains more or less stationary) and welding in a vertical orientation (known as the 2G position). Development and qualification of a weld procedure is time consuming and costly.

Welding in the 5G position is generally done with one or more welding units each welding part of the circumference of the pipe, from the bottom to the top. This method is required to assure welding material is deposited in the correct place. The method thus requires multiple starts and multiple stops for every layer of the weld. Starts and stops are disruptions in the welding process which are vulnerable for causing small irregularities or defects in the weld, which can be cause for rejection. The result is a significantly larger percentage of 5G welds that is rejected when compared to welds made in the 2G position, which is a more continuous process with less or just one starts and stops.

Further, welding has to take place in a controlled environment. Draught and water ingress need to be prevented as much as possible and delicate equipment is used that needs to be protected. This means that shelters are required to shield the welding process and equipment from environmental influences, especially when welding takes place on the deck of the vessel. Especially on board of the pipelay vessel, where deck space is always a problem, the shelters will require a lot of space which cannot be used for other purposes when the vessel is not in pipe laying mode. Also, the shelters are rigid constructions with a considerable weight. The weight of the shelter means a reduction of the payload that the vessel can transport.

Another disadvantage of horizontal multi jointing on a vessel is that the pipe sections follow a pre determined route through the multi joint facility to pass all the stations. In the case that a weld is rejected and needs to be repaired or welded again, the large length of multi joints being constructed makes it difficult to create a system where the pipe can be taken out of the normal process for repair and be re-inserted at a later stage. Additional problems arise when the sequence in which the pipe sections need to be assembled is pre determined based on pipe properties. In this case repair of one multi joint can hold up the welding process of all pipe sections behind it.

Vertical assembly of pipe sections on the side of a vessel has been disclosed in prior art. Reference is made to U.S. Pat. Nos. 6,004,071 and 6,149,347. Both applications disclose a vessel with an installation that is used for building up pipe strings in a vertical orientation. In both cases, very long sections of pipe are shown, and both applications show the pipe sections to be submerged in sea water. This can mean that the pipe end is affected by the sea water and needs processing before further handling. Also, the free hanging pipe may be subjected to forces exerted by waves or current causing the pipe section to bend or to sustain damage. Especially with very long sections this may influence workability of this solution. Neither application does relate to the J-lay method, despite the method being explained in the text. The systems of U.S. Pat. Nos. 6,004,071 and 6,149,347 aim at methods to lay pipe at higher lay speeds than the J-lay method. The use of very long sections may however lead to cumbersome handling and difficult connection of pipe sections to the already completed pipeline. The methods of U.S. Pat. Nos. 6,004,071 and 6,149,347 will further only work offshore, and cannot be used for onshore multi jointing.

### SUMMARY OF THE INVENTION

It is an object of the invention to address at least part of the problems mentioned above.

The invention provides a multi-joint installation configured to join two or more pipe sections, said multi-joint installation being rotatable about an axis of rotation between a substantially horizontal and a substantially vertical position, said multi-joint installation comprising:
two or more positioning devices for positioning the two or more pipe sections within the installation, and
at least one joining device for joining the two or more pipe sections to each other.

Such multi joint installation has the advantage that pipe sections may be loaded in the installation while the installation is located in the substantially horizontal position, while the pipe sections are joined to each other in the substantially vertical position in which joining of the pipe sections, in particular welding may be carried out more efficiently.

The multi-joint installation will normally be an elongate construction in which two or more pipe sections may be placed next to each other in longitudinal direction, i.e. the longitudinal axes of the pipe sections substantially corresponding.

The installation is in the substantially horizontal when the longitudinal axes of pipe sections positioned in it have a substantially horizontal orientation. Similarly the installation is in the substantially vertical position when the longitudinal axes of pipe sections positioned in it have a substantially vertical orientation.

The positioning devices are provided to keep the two or more pipe sections in substantially the same location with respect to the installation in particular during rotation of the installation. The positioning devices may hold the pipe sections, but may also limit the freedom of movement to keep the pipe sections within a certain area.

In an embodiment the positioning devices comprise clamp units or any other type of suitable holding device.

The positioning devices may be used to align the pipe sections with respect to each other. In an alternative embodiment a separate alignment device may be provided.

The joining device may comprise a stationary part, for instance a stationary welding platform about which the rotatable part of the installation may rotate.

In an embodiment the installation comprises a rotating device configured to rotate the installation between the substantially horizontal and the substantially vertical. In alternative embodiments external devices such as a crane may be used to rotate the installation.

In an embodiment the installation comprises one or more loading devices configured to load two or more pipe sections in the installation, when the installation is in the substantially horizontal position. Advantageously, the loading device may also be used for unloading of the pipe sections from the installation after the pipe sections are joined to each other.

In an embodiment one loading device is provided to load and/or unload each of the two or more pipe sections in the installation.

The installation can be arranged on a vessel, for instance a pipe laying vessel, but the installation may also be provided onshore.

The pipe sections that are loaded in the installation may be single joints and/or multi joints. The multi-joints may be fabricated at another location. For instance, the installation may be used offshore to join two double joints to form a quad joint. The double joints may for instance be pre fabricated onshore.

In an embodiment the installation comprises a sheltering, said at least one joining device being arranged in said sheltering. By providing a sheltering for the joining device, the joining, for instance welding of the two pipe sections may be carried out in sheltered conditions. Preferably the installation comprises one or more compartments at least partly enclosing the two or more pipe sections. In a preferred embodiment, the two or more pipe sections are enclosed in the installation by a closed compartment which comprises a lid or such which can be removed or opened for loading or unloading the two or pipe sections.

On a vessel the installation is preferably arranged at a side of the vessel. Positioning the installation at a side is advantageous for the required deck space of the total production system. Conventional multi joint factories generally have equipment positioned somewhere on the deck, where pipe is provided from one side and leaves the station on the opposite side. The multi joint installation according to the invention may load and unload using the same loading/unloading device. This results in effective use of transport equipment and therefore less deck space is required than for a conventional multi joint facility.

In an embodiment the installation is arranged such that the pipe sections enter via one end of the installation and leave via another end. Such embodiment has the advantage that the installation may be loaded and unloaded simultaneously. In such embodiment the pipe sections are preferably loaded and unloaded when the installation is in the substantially horizontal position.

In an embodiment the pipes section may be loaded at one end of the elongate installation, but unloaded at the side of the installation. In such embodiment it may be preferred to load the pipe sections while the installation is in the substantially horizontal position, while unloading preferably takes place in the substantially vertical position or another suitable non-horizontal orientation of the installation.

In another embodiment the pipe sections may be loaded and unloaded at the side of the installation. Loading takes preferably place in the substantially horizontal position. Unloading may take place in any suitable position, the substantially horizontal or vertical position or another suitable non-horizontal orientation of the installation.

In an embodiment the pipe sections may leave the installation in the vertical orientation or other suitable orientation corresponding tot the orientation to a further multi-joint tower or a pipe-laying tower to which the pipe sections are transported. This may be especially advantageous since this method may eliminate the need for rotating the multi joint installation and thereby save critical time. Also it is advantageous to present the completed multi joint to the tower in the same approximate orientation that it will be handled in the tower. A separate pipe upender to load multi joints into the tower may then not be required.

In an embodiment the installation may provide efficient routing of pipe sections from one welding station to the next one, which welding stations may advantageously be arranged close together for instance at the side of the vessel. Furthermore, since the multi joints pass the same point several times during loading and unloading in the multi joint installation, it is possible to create a side loop in the production process. If a weld defect is established, the side loop can be used to take a multi joint out of the process, prepare the multi joint for repair or re-welding, insert the multi joint back into the process at an earlier stage, and repair or re-weld the multi joint. The multi joint can even be returned at the same position in the production sequence as it was, since it can pass a multi joint that was welded during the preparation for repair if this is parked in the side loop position. This makes it an efficient process, without losing a lot of critical time, or holding up all multi joints behind it from the time the weld is rejected until the weld has been accepted.

Additionally welding may take place while the pipe sections to be joined are in a substantially vertical position, i.e. the installation is in the substantially vertical position, which is the approximately same position as in the J-lay tower. As a result less welding procedures may have to be qualified to perform all welding activities for a project.

Further advantage of the invention can be made when the multi joint installation according to the invention is also used for onshore multi jointing, provided there is a suitable location to place the rotating tower. This may omit the need for qualification of more welding procedures.

In an embodiment of the installation the pipe sections may be contained in closed compartments. The design specification of the installation can ensure that workability is guaranteed up to specified weather conditions. Also pipe sections will not be in contact with sea water, and be protected from deformation or damage prior to further processing.

The invention further provides a method for joining pipe sections together, the method comprising the steps:
providing a multi-joint installation for joining two or more pipe sections, said multi-joint installation being rotatable between a substantially horizontally position and a substantially vertical position,
inserting two or more pipe sections in the multi-joint installation, the multi-joint installation being in the substantially horizontal position,
rotating the multi-joint installation to the substantially vertical position,
at least partly joining the two or more pipe sections, and
unloading the joined two or more pipe sections from the multi-joint installation.

### BRIEF DESCRIPTION OF THE DRAWINGS

The invention will be further illustrated by the following figures:

FIG. 1 shows a side view of an embodiment of the invention.

FIG. 2 shows a side view of an alternative embodiment of the invention.

FIG. 3 shows a cross section of the multi joint installation in horizontal position.

FIG. 4 shows a partial longitudinal section of the upper part of the installation.

FIG. 5 shows a cross section across the upper part of the installation.

FIG. 6 shows a cross section of the lower part of the installation.

FIG. 7 shows a side view of a part of FIG. 5.

FIG. 8 shows a top view of a possible embodiment of the welding station floor.

FIG. 9 shows a top view of an alternative for a possible embodiment of the welding station floor.

FIG. 10 shows a cross section over the bearing element of the installation.

FIG. 11 shows a cross section of a seal structure.

### DETAILED DESCRIPTION OF THE PREFERRED EMBODIMENTS

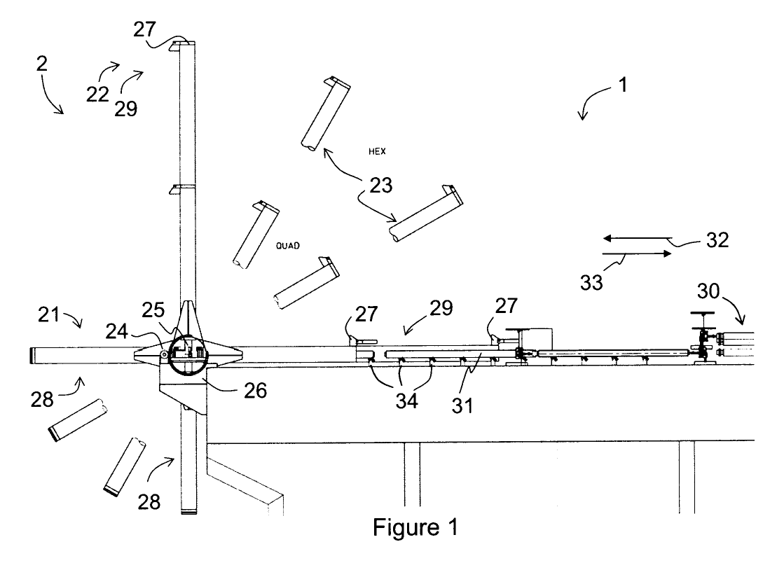

FIG. 1 shows a side view of an embodiment of the invention. Offshore construction vessel 1 comprises a multi joint installation 2. Installation 2 can be rotated from a horizontal position 21 to a vertical position 22. Several intermediate positions 23 have been partially indicated to show the trajectory the installation 2 will follow during rotation. Multi joint installation 2 comprises a lower section 28 to contain a first part of the multi joint and an upper section 29 to contain a second part of the multi joint. The first and second parts of the multi joint are welded to each other in welding station 25. The lower 28 and upper 29 sections are connected via a bearing element 24. Installation 2 is connected to vessel 1 via bearing element 24 which is hung of in structure 26. The top of the installation can be closed off via a lid 27 to ensure the welding is not hindered by water or draught.

Pipe sections 31 to be welded are fed into installation 2 from the deck of the vessel in direction 32 via deck rollers 34. Also containers 28 and 29 comprise rollers (not shown) for transportation of the pipe sections to their respective welding positions. Storage means 30 may be provided on the deck for the supply of pipe sections. FIG. 1 shows an installation suitable to weld pipe sections of both the same as different length, for example a quadruple joint (48 m) can be contained in upper section 29 and a double joint (24 m) can be contained in the lower section 28 for welding into a hexjoint (72 m). The finished multi joint leaves installation 2 in reversed direction 33 as it came in. However, the same installation may also be used to join two double joints, a single joint and a double joint or any other suitable combination of two pipe sections.

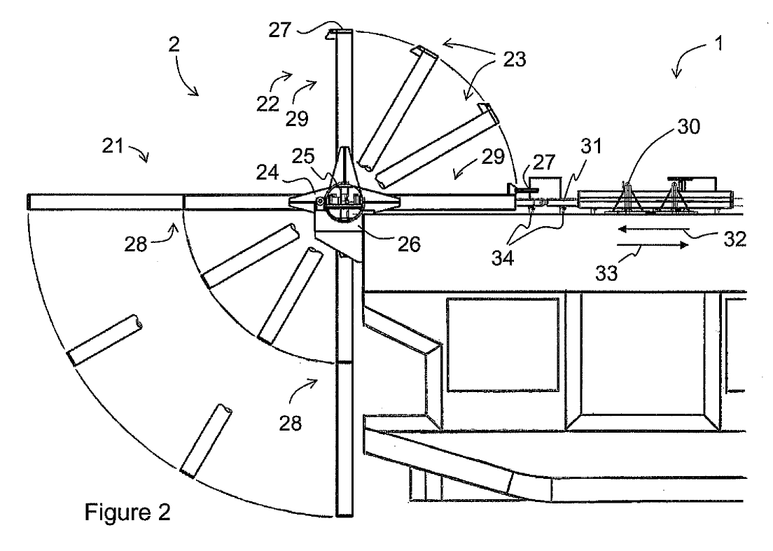

FIG. 2 shows another embodiment of the invention. All numerals used are similar to those used in FIG. 1. In this figure, the longer part of the two joints to be joined is contained by the lower section 28.

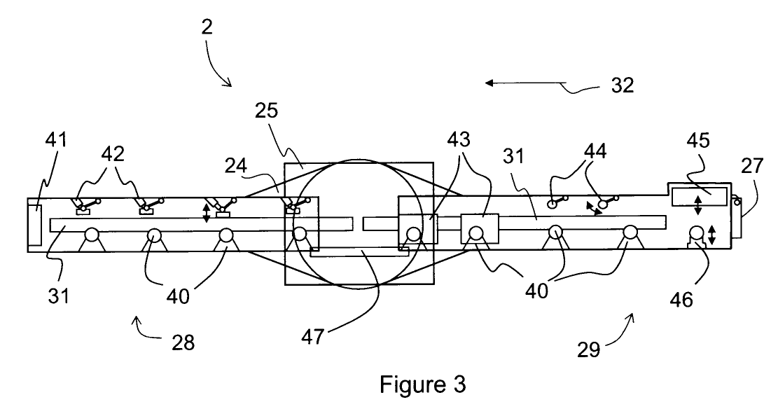

FIG. 3 shows a cross section of the multi joint tower 2. Upper and lower sections 28, 29 are connected via a bearing element 24 which is hung off to the side of the vessel and provides rotating capability. Rotating of the installation may be provided by a rotating device of the installation, or by an external device, such as a crane or winch. Welding station 25 is preferably stationary and provides room for bearing element 24 to rotate freely. Welding station floor 47 is indicated in the drawing.

The lower section 28 and the upper section 29 each comprise rollers 40 which are used to load the pipe sections in the installation in direction 32. A bumper plate 41 is provided at the lower end of section 28 to prevent damage in the case a pipe rolls too far. The bumper plate 41 may also be used for height adjustment of the lower pipe section in the installation 2.

Lower section 28 further comprises clamp units 42 that can engage pipe section 31 and hold it steady for welding when the installation 2 is brought in vertical position. In the shown embodiments the clamp unit 42 and 44 are indicated. However, it may not continuously be required that all the Clamps/rollers 42 and 44 need to clamp the pipe, i.e. there may be some clearance between clamp/roller and pipe.

Upper section 29 comprises an alignment device, often referred to as external line up tool (ELUT) 43 for fine line up of the upper pipe section with the lower pipe section. ELUT 43 may be integrated with one or more rollers 40. These line up tools are known from the art. Section 29 further comprises roller clamps 44 for guidance of the pipe during line up and welding. Clamps 44 do not have to carry the pipe weight, this is done by the ELUT 43.

In the top of section 29 optionally an internal line up clamp in garage 45 may be provided for additional line up precision and backing support during welding of the first weld layers. To allow passage of pipe sections 31 the ILUC garage 45 needs to be movable between a position to insert the ILUC in the pipe and a parking position which allows pipe sections to pass. To allow the ILUC garage to be positioned above the pipe 31, one or more rollers 46 may have to be made retractable.

Alternatively the ILUC may be inserted in one of the pipe sections when this is still on the vessel deck. After welding the ILUC can be removed, e.g. during coating activities.

In the shown embodiments the clamp units 42 and 44 are configured to clamp the pipe sections against the rollers 40. In alternative embodiments clamping devices may be provided which actively clamp the pipe sections from different sides of the pipe section. However, for effective use of the installation it may not be required or only temporarily be required to clamp the pipe; some clearance between clamp/roller and pipe section may be possible.

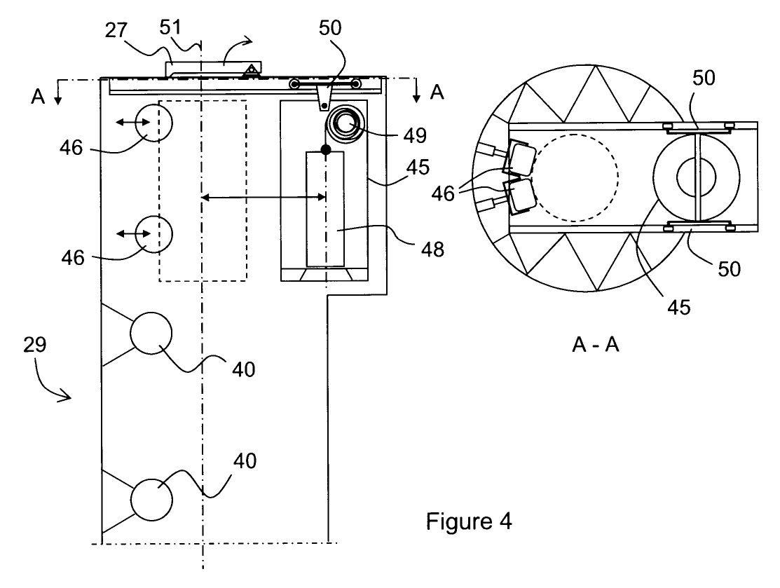

FIG. 4 shows the top of upper section 29 in a bit more detail. ILUC garage 45 comprises at least the ILUC 48 itself, and an umbilical winch to lower and raise the ILUC in and out of the pipe. Garage 45 is mounted into upper section 29 with a transportation system 50 that allows movement of the garage in and out of the centre line 51 of the pipe sections to be welded.

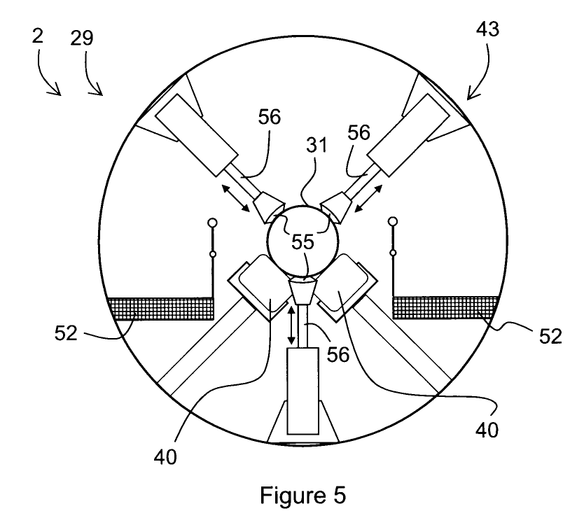

FIG. 5 shows a section across upper section 29 at the height of the external line up tool (ELUT) 43. The ELUT may have a conventional design, i.e. a (large) clamp gripping around the pipe, however since the pipe loads are not so high different concepts may be feasible, for instance multiple pads 55 that engage on pipeline 31 from different directions. By changing the length of the elements 56 which may for instance consist of pistons, screws or threaded rods, the pipe end can be maneuvered into the desired location. Pipe rotation may be used on at least one of the pipe sections in order to obtain the best possible line up between the two pipe ends to be joined.

One or more walkways 52 may be provided to ease access to the equipment in the installation 2.

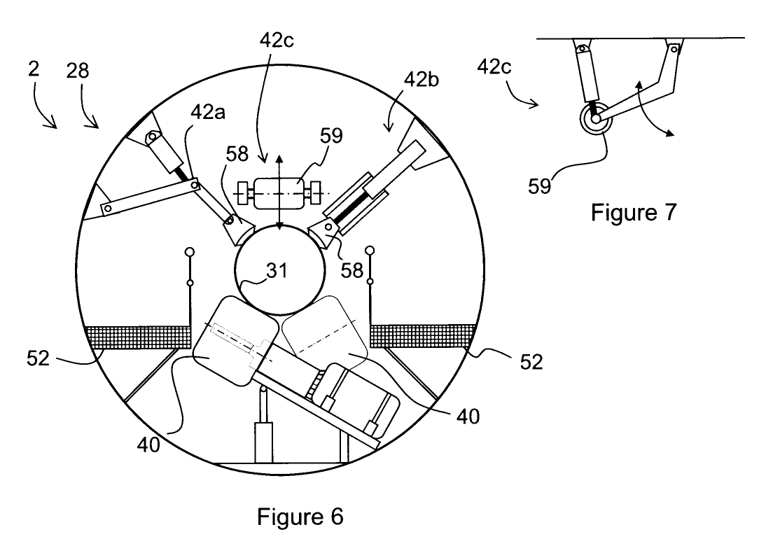

FIG. 6 shows a section across the lower section 28. Pipe section 31 is supported by rollers 40. The clamp system 42 to secure the pipe during line up and welding can be made in many different ways, using hydraulic, electrical or pneumatic systems to firmly press pads 58 onto pipe 31. Several methods are indicated with numbers 42a, 42b and 42c. Many more embodiments can be thought of. Clamps 42a and 42b show a system with pads 58 that are pressed onto the pipe with for example hydraulic cylinders. Clamp 42c shows in frontal view a solution where a cylindrical contact element 59 is hingeably connected to the wall of section 28 and can be pressed down with a cylinder.

FIG. 7 shows a side view of a possible embodiment of clamp 42c.

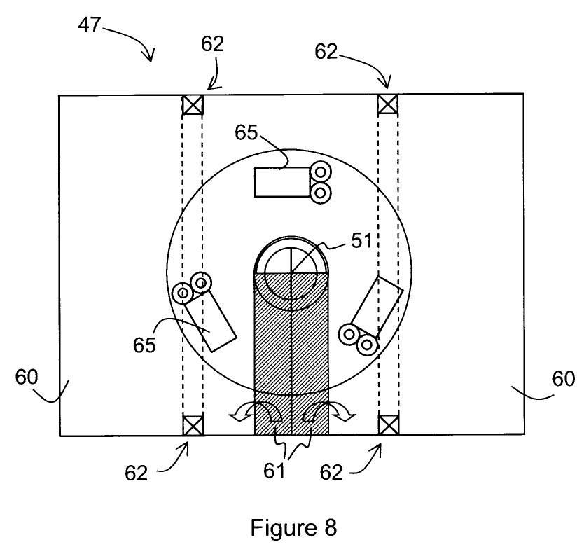

FIG. 8 shows a top view of the floor 47 of the welding station. This floor consists of fixed parts 60 and movable parts 61. In an embodiment the majority of the floor is fixed and a small recess can be opened and closed for instance via hatches. Welding equipment 65 can be moved around the pipe when the hatches are closed. Welding equipment may move relative to the welding floor on wheels or tracks or the like, alternatively equipment may be stationary on a part of the welding floor that can be rotated around the pipe.

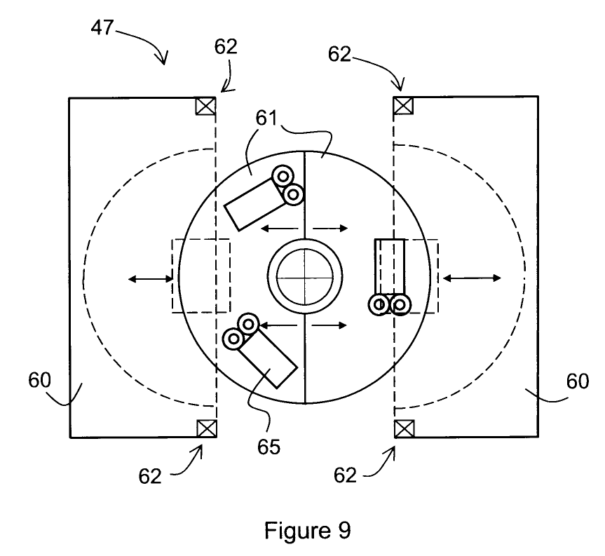

Another embodiment is shown in FIG. 9 where a larger part of the welding station floor moves in two halves.

With parts 61 in opened position a passage is created to allow the pipe and multi joint tower to rotate from horizontal to vertical or vice versa. With the segments 61 in closed position the whole circumference of the pipe can be approached by equipment and personnel.

Bearing elements 62 are located between the stationary and rotating part of the multi joint tower in order to provide a seal against wind and water entering the working station.

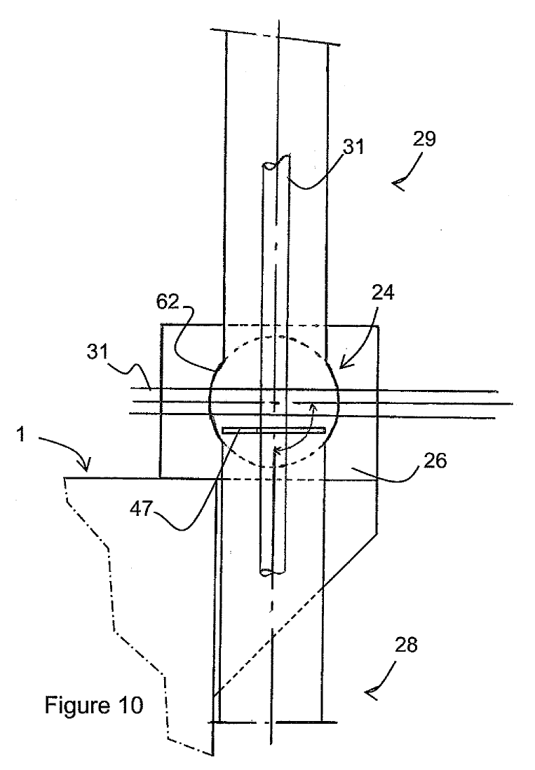

FIG. 10 shows a cross section over the bearing element of the installation. Bearing part 24 rotates into the structure 26 via bearing elements 62 which extend partly or completely around the circumference of the bearing part 24. Structure 26 is rigidly connected to the side of vessel 1. Welding floor 47 is part of the structure 26 and remains stationary; the multi joint tower rotates around it.

Pipe section 31 is shown in both horizontal and vertical orientation to indicate the rotation direction of the multi-joint tower. An outline of the lower part 28 and upper part 29 of the multi-joint tower are only drawn in vertical orientation for clarity.

Again, different embodiments can be thought of to rotate the multi joint tower, for instance hydraulic means or means with a gearing. Alternatively a winch system may be used. The bearing construction could be based on a large diameter glacier bearing, support rollers or a hinge pin type construction.

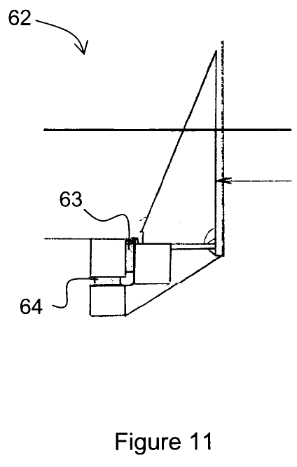

FIG. 11 shows a cross section of a possible embodiment of a glacier bearing seal construction. By using two bearing surfaces (one vertical 63 and one horizontal 64) with glacier bearing material (Teflon based or Orkot based or similar) the bearing can take both load and seal against wind and water. Additional sealing may be provided as required.

As many widely different embodiments of the present invention can be made without departing from the spirit and scope thereof, it is to be understood that the invention is not limited to specific embodiments thereof, except as defined in the claims.

What is claimed is:

1. A multi-joint installation configured to join two or more pipe sections, said multi-joint installation being rotatable about an axis of rotation between a substantially horizontal and a substantially vertical position, said multi-joint installation comprising:
two or more holding devices for holding two or more pipe sections, and
at least one joining device for joining the two or more pipe sections to each other.

2. The installation of claim 1, comprising one or more aligning units for aligning the two or more pipe sections with respect to each other.

3. The installation of claim 1, wherein said joining device comprises a welding device.

4. The installation of claim 3, wherein said welding device is configured to join two pipe sections in the substantially vertical position.

5. The installation of claim 1, wherein said installation comprises two or more welding devices, each welding device being configured to weld ends of two aligned pipe sections to each other.

6. The installation of claim 1, wherein said installation comprises a sheltering, said at least one joining device being arranged in said sheltering.

7. The installation of claim 1, wherein said installation comprises a rotating device configured to rotate the installation between the substantially horizontal and the substantially vertical.

8. The installation of claim 1, wherein said installation comprises one or more loading devices configured to load two or more pipe sections in the installation, when the installation is in the substantially horizontal position.

9. The installation of claim 1, wherein said two or more pipe sections comprise single joints and/or multi joints.

10. A method for joining pipe sections together comprising the steps:
providing a multi-joint installation for joining two or more pipe sections, said multi-joint installation being rotatable between a substantially horizontally position and a substantially vertical position,
inserting two or more pipe sections in the multi-joint installation, the multi-joint installation being in the substantially horizontal position,
rotating the multi-joint installation to the substantially vertical position,
at least partly joining the two or more pipe sections, and
unloading the joined two or more pipe sections from the multi-joint installation.

11. The method of claim 10, wherein the method comprises the step of rotating the multi-joint installation to the substantially horizontal position, before unloading the joined two or more pipe sections.

12. The method of claim 10, wherein the joined two or more pipe sections are unloaded in a substantially vertical position.

13. The method of claim 10, wherein the method comprises the step of rotating the multi-joint installation to a position having an orientation substantially equal to an orientation of a further multi-joint installation or pipe-laying tower, before unloading the joined two or more pipe sections.

14. The method of claim 10, wherein the two or more pipe section are completely joined to each other, when the multi-joint installation is in the substantially vertical position.

15. The method of claim 10, wherein the two or more pipe sections are partly joined to each other, when the multi-joint installation is in the substantially vertical position, and after the step of rotating the multi-joint installation to the substantially horizontal position, the joining of the two or more pipe sections is completed.

16. The method of claim 10, wherein said multi joint installation is arranged on a vessel.

17. The method of claim 10, wherein said multi-joint installation is arranged onshore.

18. The method of claim 10, comprising of before the step of rotating the multi-joint installation to the substantially vertical position, the step of securing the one or more pipe sections inserted in the multi-joint installation.

19. The method of claim 10, wherein said loading and unloading of a pipe section is carried out with a single loading/unloading device.

20. A vessel comprising the multi-joint installation of claim 1.

21. The vessel of claim 20, further comprising a pipe-laying installation. The vessel of claim 20, wherein said pipe-laying installation comprises a J-lay tower.
